(19) United States
(12) Patent Application Publication
(10) Pub. No.: US 2007/0198265 A1
(43) Pub. Date: Aug. 23, 2007

(54) System and method for combined state- and phone-level and multi-stage phone-level pronunciation adaptation for speaker-independent name dialing

(75) Inventor: Kaisheng N. Yao, Dallas, TX (US)

Correspondence Address: TEXAS INSTRUMENTS INCORPORATED, P O BOX 655474, M/S 3999, DALLAS, TX, 75265, US

(73) Assignee: Texas Instruments, Incorporated, Dallas, TX (US)

(21) Appl. No.: 11/359,973

(22) Filed: Feb. 22, 2006

(51) Int. Cl. G10L 15/04

(52) U.S. Cl. 704/254

(57) ABSTRACT

A system for, and method of, combined state- and phone-level pronunciation adaptation. One embodiment of the system includes: (1) a state-level pronunciation variation analyzer configured to use an alignment process to compare base forms of words with alternate pronunciations and generate a confusion matrix, (2) a state-level pronunciation adapter associated with the state-level pronunciation variation analyzer and configured to employ the confusion matrix to generate, in plural states, sets of Gaussian mixture components corresponding to alternative pronunciation realizations and enlarge the sets by tying the Gaussian mixture components across the states based on distances among the Gaussian mixture components and (3) a phone-level pronunciation adapter associated with the state-level pronunciation adapter and configured to employ phone-level re-write rules to generate multiple pronunciation entries. The phone-level pronunciation adapter may be embodied in multiple stages.

### CROSS-REFERENCE TO RELATED APPLICATION

The present invention is related to U.S. patent application Ser. No. 11/195,895 by Yao, entitled “System and Method for Noisy Automatic Speech Recognition Employing Joint Compensation of Additive and Convolutive Distortions,” filed Aug. 3, 2005, U.S. patent application Ser. No. 11/196,601 by Yao, entitled “System and Method for Creating Generalized Tied-Mixture Hidden Markov Models for Automatic Speech Recognition,” filed Aug. 3, 2005, and U.S. patent application Ser. No. [Attorney Docket No. TI-60422] by Yao, entitled “System and Method for Text-To-Phoneme Mapping with Prior Knowledge,” all commonly assigned with the present invention and incorporated herein by reference.

### TECHNICAL FIELD OF THE INVENTION

The present invention is directed, in general, to automatic speech recognition (ASR) and, more particularly, to a system and method for combined state- and phone-level or multi-stage phone-level pronunciation adaptation for speaker-independent name dialing.

### BACKGROUND OF THE INVENTION

Speaker-independent name dialing (SIND) is an important application of ASR to mobile telecommunication devices. SIND enables a user to contact a person by simply saying that person's name; no previous enrollment or pre-training of the person's name is required.

Several challenges, such as robustness to environmental distortions and pronunciation variations, stand in the way of extending SIND to a variety of applications. However, providing SIND in mobile telecommunication devices is particularly difficult, because such devices have quite limited computing resources. Since SIND aims at recognizing a list of names, which may amount to thousands, methods that generate phoneme sequence of names are necessary. However, because of the above-mentioned limited computing resources in mobile communication devices, a large dictionary with many entries cannot be used for SIND. Instead, other methods must be used, such as a decision-tree-based pronunciation model (DTPM) (see, e.g., Suontausta, et al., “Low Memory Decision Tree Method for Text-To-Phoneme Mapping,” in ASRU, 2003) that generates a single pronunciation for each name online.

It is generally known that ASR can still benefit from improvements at all processing levels. Most of the benefits so far came from the acoustic level, e.g., by introducing dynamic features (see, e.g., Furui, et al., “Speaker-Independent Isolated Word Recognition Using Dynamic Features of Speech Spectrum,” IEEE Trans. Acoust. Speech Signal Process, pp. 52-59, 1986) and adaptation of acoustic models (see, e.g., Gales, et al., “Robust Speech Recognition in Additive and Convolutional Noise Using Parallel Model Combination,” Computer Speech and Language, vol. 9, pp. 289-307, 1995, Woodland, et al., “Improving Environmental Robustness in Large Vocabulary Speech Recognition,” in ICASSP, 1996, pp. 65-68, and Gauvain, et al., “Maximum a Posteriori Estimation for Multivariate Gaussian Mixture Observations of Markov Chains,” IEEE Trans. on Speech and Audio Processing, vol. 2, no. 2, pp. 291-298, 1994). As the focus of ASR has gradually shifted from carefully read speech in quiet environments to real applications for normal speech in noisy environments, new challenges have occurred that require much effort in other levels of ASR. One challenge is pronunciation variation caused by many factors (see, e.g., Strik, “Pronunciation Adaptation at the Lexical Level,” in ITRW on Adaptation Methods for Speech Recognition, 2001, pp. 123-130), such as different speaking styles, degree of formality, environment, accent or dialect and emotional status. In addition to these factors, in mobile applications of SIND, such variation may also be due to mismatches between a data-driven pronunciation model, e.g., a decision-tree-based pronunciation model (see, e.g., Suontausta, et al., supra), trained from transcriptions of read speech and the actual pronunciation by human users. It is critical to have methods that can compensate effects of pronunciation variation on ASR.

Methods have been proposed to deal with pronunciation variation. These include lexicon modeling at the phone level using re-write rules (see, e.g., Yang, et al., “Data-Driven Lexical Modeling of Pronunciation Variations for ASR,” in ICSLP, 2000), decision trees (see, e.g., Riley, et al., “Stochastic Pronunciation Modeling from Hand-Labelled Phonetic Corpora,” Speech Communication, vol. 29, pp. 209-224, 1999), neural networks (see, e.g., Fukada, et al., “Automatic Generation of Multiple Pronunciations Based on Neural Networks,” Speech Communication, vol. 27, pp. 63-73, 1999), and confusion matrices (see, e.g., Torre, et al., “Automatic Alternative Transcription Generation and Vocabulary Selection for Flexible Word Recognizers,” in ICASSP, 1997, vol. 2, pp. 1463-1466).

Other methods deal with pronunciation variation at the state level. These include sharing mixture components at the state level (see, e.g., Liu, et al., “State-Dependent Phonetic Tied Mixtures with Pronunciation Modeling for Spontaneous Speech Recognition,” IEEE Trans on Speech and Audio Processing, vol. 12, no. 4, pp. 351-364, 2004, Saraclar, et al., “Pronunciation Modeling by Sharing Gaussian Densities Across Phonetic Models,” Computer Speech and Language, vol. 14, pp. 137-160, 2004, Yun, et al., “Stochastic Lexicon Modeling for Speech Recognition,” IEEE signal processing letters, vol. 6, no. 2, pp. 28-30, 1999, and Luo, Balancing Model Resolution and Generalizability in Large Vocabulary Continuous Speech Recognition, Ph.D. thesis, The Johns Hopkins University, 1999). In state-level methods, the HMM states of the phoneme's model are allowed to share Gaussian mixture components with the HMM states of the models of the alternate pronunciation realization. However, some significant disadvantages render these methods inappropriate for use in SIND in mobile communication devices. First, some state-level methods (e.g., Liu, et al., supra, and Saraclar, et al., supra) involve complex state-level operations such as splitting and merging. These operations are impractical in mobile communication devices due to their limited computing resources for SIND. Second, it is known that pronunciation variation is context-dependent. Some of phone-level methods (see, e.g., Torre, et al., supra) do not account for that fact. Third, phone-level methods have not been applied to SIND, since SIND has a unique pronunciation variation caused by differences between pronunciations from data-driven pronunciation models and human speakers.

Accordingly, what is needed in the art is a new technique for dealing with pronunciation variation for SIND that is not only relatively fast and accurate, but also more suitable for use in mobile telecommunication devices than are the above-described techniques.

### SUMMARY OF THE INVENTION

To address the above-discussed deficiencies of the prior art, the present invention introduces methods and systems for combined state- and phone-level pronunciation adaptation.

The foregoing has outlined preferred and alternative features of the present invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the present invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a high level schematic diagram of a wireless telecommunication infrastructure containing a plurality of mobile telecommunication devices within which the system and method of the present invention can operate;

FIG. 2 illustrates a high-level block diagram of a DSP located within at least one of the mobile telecommunication devices of FIG. 1 and containing one embodiment of a system for combined state- and phone-level pronunciation adaptation for SIND constructed according to the principles of the present invention;

FIG. 3 illustrates a graphical representation of an exemplary sharing of Gaussian mixture components between two phonemes: “ax” and “er;”

FIG. 4 illustrates a flow diagram of one embodiment of a method of combined state- and phone-level pronunciation adaptation for SIND carried out according to the principles of the present invention;

FIG. 5 illustrates a graphical representation of one example of extraction of pronunciation variation, together with its corresponding phone context;

FIG. 6 illustrates a graphical representation of one example of tree-structured rewrite rules for a phone variation pattern from “ah” to “ax;”

FIG. 7 illustrates a high-level block diagram of one embodiment of a system for multi-stage phone-level pronunciation adaptation for SIND constructed according to the principles of the present invention;

FIG. 8 illustrates a graphical representation of experimental results, namely a word error rate (WER) by pronunciation adaptation occurring at only a phone level as a function of a probability threshold θₚ;

FIG. 9 illustrates a graphical representation of experimental results, namely a WER by pronunciation adaptation occurring at combined state and phone levels as a function of a probability threshold θₚ; and

FIG. 10 illustrates a graphical representation of experimental results, namely phoneme accuracy versus stage index pertaining to the multi-stage phone-level pronunciation adaptation technique described herein.

### DETAILED DESCRIPTION

Certain embodiments of a combined state- and phone-level pronunciation adaptation technique carried out in accordance with the principles of the present invention (hereinafter “combined technique”) will now be described. The combined technique compensates for pronunciation variation at two levels. At the state level, pronunciation variation is carried out by mixture-sharing. At the phone level, probabilistic re-write rules are applied to generate multiple pronunciations per word. The re-write rules are context-dependent and therefore enable the combined technique to deal more effectively with pronunciation variation. As will be seen, certain embodiments of the combined technique introduce novel construction of rule sets, rule pruning and generation of multiple pronunciations. The efficacy of the phone-level re-write rules for SIND in mobile communication devices will be demonstrated through experiments set forth below. In addition, phone-level adaptation may be advantageously carried out in a multi-stage architecture to be described. A memory- and computation-efficient mixture-sharing technique will also be introduced that is particularly advantageous in extending SIND in mobile communication devices. Experiments demonstrating the efficacy of both the combined technique and the multi-stage phone-level technique will also be shown below. They will show that, compared to a baseline SIND system with a well-trained decision-tree-based pronunciation model, one embodiment of the combined technique decreases word error rate (WER) by 45%.

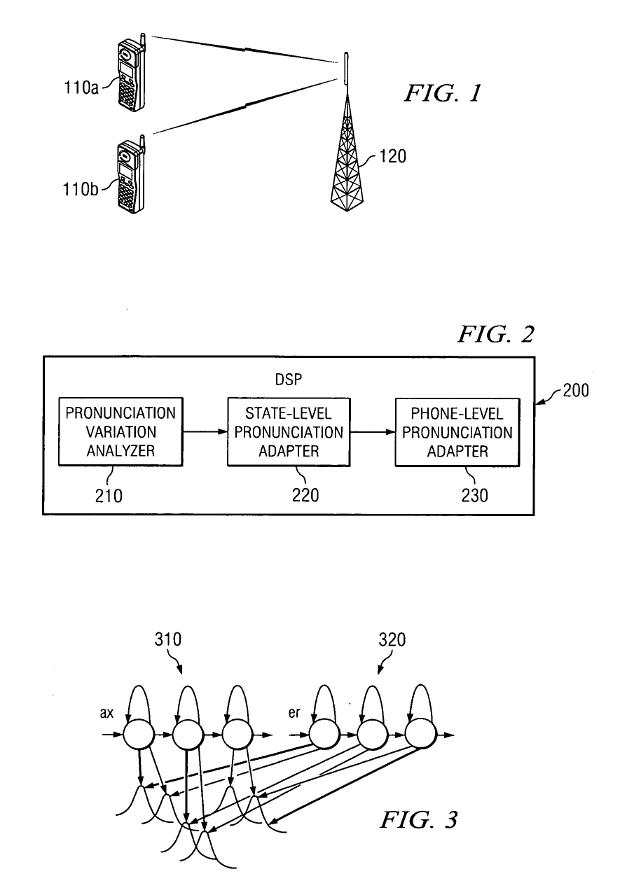

Referring initially to FIG. 1, illustrated is a high level schematic diagram of a wireless telecommunication infrastructure, represented by a cellular tower 120, containing a plurality of mobile telecommunication devices 110a, 110b within which the system and method of the present invention can operate.

One advantageous application for the system or method of the present invention is in conjunction with the mobile telecommunication devices 110a, 110b. Although not shown in FIG. 1, today's mobile telecommunication devices 110a, 110b contain limited computing resources, typically a DSP, some volatile and nonvolatile memory, a display for displaying data, a keypad for entering data, a microphone for speaking and a speaker for listening. Certain embodiments of the present invention described herein are particularly suitable for operation in the DSP. The DSP may be a commercially available DSP from Texas Instruments of Dallas, Tex.

Having described an exemplary environment within which the system or the method of the present invention may be employed, various specific embodiments of the system and method will now be set forth. Accordingly, turning now to FIG. 2, illustrated is a high-level block diagram of a DSP located within at least one of the mobile telecommunication devices of FIG. 1 and containing one embodiment of a system for combined state- and phone-level pronunciation adaptation for SIND constructed according to the principles of the present invention. The system includes a pronunciation variation analyzer 210. The pronunciation variation analyzer 210 is configured to use an alignment process to compare base forms of words with alternate pronunciations and generate a confusion matrix. The system further includes a state-level pronunciation adapter 220. The state-level pronunciation adapter 220 is associated with the pronunciation variation analyzer 210 and is configured to employ the confusion matrix to generate, in plural states, sets of Gaussian mixture components corresponding to alternative pronunciation realizations and enlarge the sets by tying the Gaussian mixture components across the states based on distances among the Gaussian mixture components. The system further includes a phone-level pronunciation adapter 230. The phone-level pronunciation adapter 230 is associated with the state-level pronunciation adapter 220 and is configured to employ phone-level re-write rules to generate multiple pronunciation entries.

Although the present invention encompasses performing state-level and phone-level pronunciation adaptation independently or in any order, it has proven particularly advantageous to perform adaptation at the state level before adaptation at the phone level for the following reasons. First, the combined technique performs state-level pronunciation variation by mixture-sharing. Due to the first-order Markovian property of HMMs, mixture-sharing in an HMM may not be able to use long-term context dependency. Therefore, mixture-sharing should occur before phone-level pronunciation adaptation, since the phone-level pronunciation adaptation introduced herein is context-dependent. Second, state-level pronunciation adaptation may be viewed as an integral part of acoustic model training. In addition to dealing with pronunciation variation, the combined technique increases the number of mixture components per state, but does not increase total number of mixture components.

As stated above, pronunciation adaptation at the state level is carried out through mixture-sharing. The mixture-sharing is developed in consideration of the following. First, for SIND, each state may have very limited number of Gaussian components. Further performance improvement may be achieved by increasing the mixture components of each state. However, this may drastically increase the size of the resulting acoustic model, rendering it unsuitable for mobile communication devices. Second, pronunciation variation may be performed at the state level (see, e.g., Liu, et al., supra, Saraclar, et al., supra, Yun, et al., supra, and Luo, supra). However, as described above, direct use of these techniques often is prohibitive for mobile communication devices.

The combined technique is developed to incorporate pronunciation variation at the state level without adversely affecting acoustic model size. Generally speaking, the combined technique involves tying mixtures with alternate pronunciations and thereafter re-training the acoustic models. FIG. 3 illustrates the concept. In FIG. 3, mixture-sharing may be done among similar phones, such as a “ax” phone 310 and an “er” phone 320. The ability to discriminate phones is attained by: (1) using different mixture weights for mixture-tying and (2) sharing different mixture components.

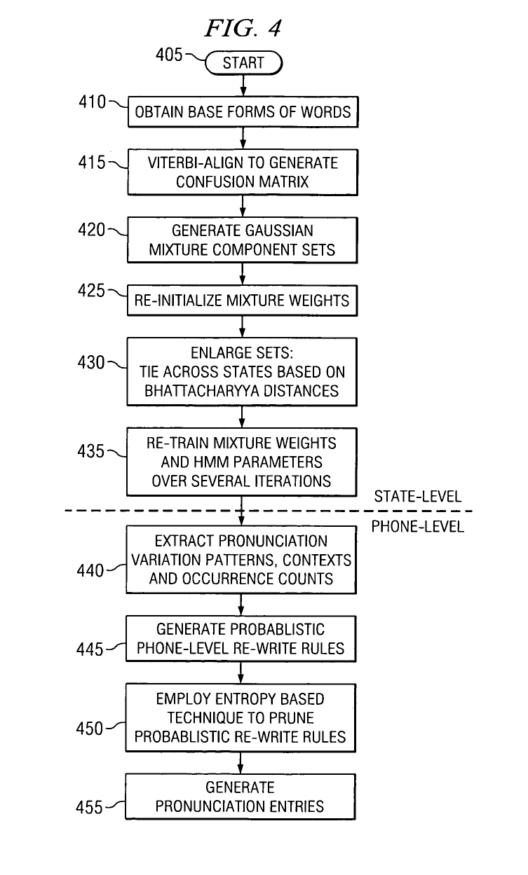

Turning now to FIG. 4, illustrated is a flow diagram of one embodiment of a method of combined state- and phone-level pronunciation adaptation for SIND carried out according to the principles of the present invention. The method of FIG. 4 is divided into state-level and phone-level pronunciation variation domains for the sake of clarity and begins in a start step 405.

One embodiment of state-level pronunciation variation is carried out as follows:
1. Analyze pronunciation variation. Obtain the base forms of words (in a step 410) from data-driven techniques, such as a decision-tree-based pronunciation model (see, e.g., Suontausta, et al., supra). Then employ a Viterbi alignment process to obtain a confusion matrix of phone substitution, insertion and deletion, by comparison of base forms with alternate pronunciations (in a step 415).
2. For each state s:
(a) Given a Gaussian component G_{sc} at state s in a phone, pool Gaussian components for sharing with G_{sc} from those Gaussian components in states of alternate pronunciation realizations. Then use the Bhattacharyya distance to measure Gaussian component distances to G_{sc}, appending those pooled components with the smallest Bhattacharyya distances (in a step 420). Given two Gaussian components, G₁(μ₁,Σ₁) and G₂(μ₂,Σ₂), the Bhattacharyya distance is defined as:

$$D ( {G}_{1} , {G}_{2} ) = \frac{1}{8} {( {μ}_{1} - {μ}_{2} )}^{T} {( \frac{{\sum }_{1} + {\sum }_{2}}{2} )}^{- 1} \times ( {μ}_{1} - {μ}_{2} ) + \frac{1}{2} ln \frac{\vert ( {\sum }_{1} + {\sum }_{2} ) / 2 \vert}{{\vert {\sum }_{1} \vert}^{1 / 2} \cdot {\vert {\sum }_{2} \vert}^{1 / 2}} , \qquad ( 1 )$$
where μ and Σ are the mean and variance of a Gaussian component.
(b) Re-initialize mixture weights (in a step 425) by the following:

$${w}_{sc} = \{ \begin{matrix}{d}_{t} & if c ∈ \{ 1 , … , {K}_{s} \} \\ \frac{1 - {d}_{1} {K}_{s}}{K - {K}_{s}} & otherwise ,\end{matrix} \qquad ( 2 )$$
where

$${d}_{t} = min ( 0.9 / {K}_{s} , \frac{2}{K} ) .$$

K and Kₛ are the new and original number of the Gaussian components at state s. Usually, K is set to 10.
(c) Enlarge the set of mixture components of a state with the Gaussian components of other states having the smallest Bhattacharyya distances to its original mixture components (in a step 430).
3. Re-train mixture weights (in a step 435) via an Expectation-Maximization (E-M) algorithm (see, e.g., Rabiner, et al., Fundamentals of Speech Recognition, Prentice Hall P T R, 1993)
4. Re-train all parameters of HMMs for several iterations (also in the step 435).

Having described one embodiment of state-level pronunciation adaptation, one embodiment of phone-level pronunciation adaptation will now be described, again with reference to FIG. 4. In statistical speech recognition, a word sequence is decoded via the following MAP principle:

$$\hat{W} = arg {max}_{W} p ( X \text{\vert} W ) p ( W ) \qquad ( 3 )$$

where X is an observed acoustic feature sequence and W is a word sequence. For SIND, the word is composed of a sequence of sub-word phonemes, which is called the “lexicon.” When multiple pronunciations of the word are considered, the above Equation (3) extends to:

$$\hat{W} = arg {max}_{W , P} p ( X \text{\vert} P ) p ( P \text{\vert} W ) p ( W ) \qquad ( 4 )$$

where P is a phoneme sequence of word sequence W. The pronunciation model p(p|W) should cover possible variants of P given W. Performance of the pronunciation model is important to the successful operation of a SIND system.

As described above, phone-level pronunciation adaptation may be performed using probabilistic re-write rules. The phone-level pronunciation adaptation technique includes four steps. First, patterns of phone-level variations are extracted, together with their phone contexts and occurrence counts (in a step 440). Second, a set of phone-level re-write rules is derived (in a step 445). Third, an entropy-based technique is used to prune the rule set (in a step 450). Fourth, these rules are applied to base forms to generate multiple pronunciation entries (in a step 455).

One embodiment of phone-level pronunciation adaptation will now be described. Two dictionaries are used to extract phone-level pronunciation variations (the step 440 of FIG. 4). The first dictionary includes base forms, and the second includes surface forms which are, by definition, variants of the base forms. In SIND, the base forms are typically generated from a data-driven technique, such as a decision-tree-based pronunciation model (see, e.g., Suontausta, et al., supra). The surface forms are often obtained from a manual dictionary. As an example, the base form for name ADAM is the pronunciation “ae d ah m.” The surface form of the name may be “ae d ax m,” which is different from the base form with the substitution of the third phone “ah” in the base form by “ax.”

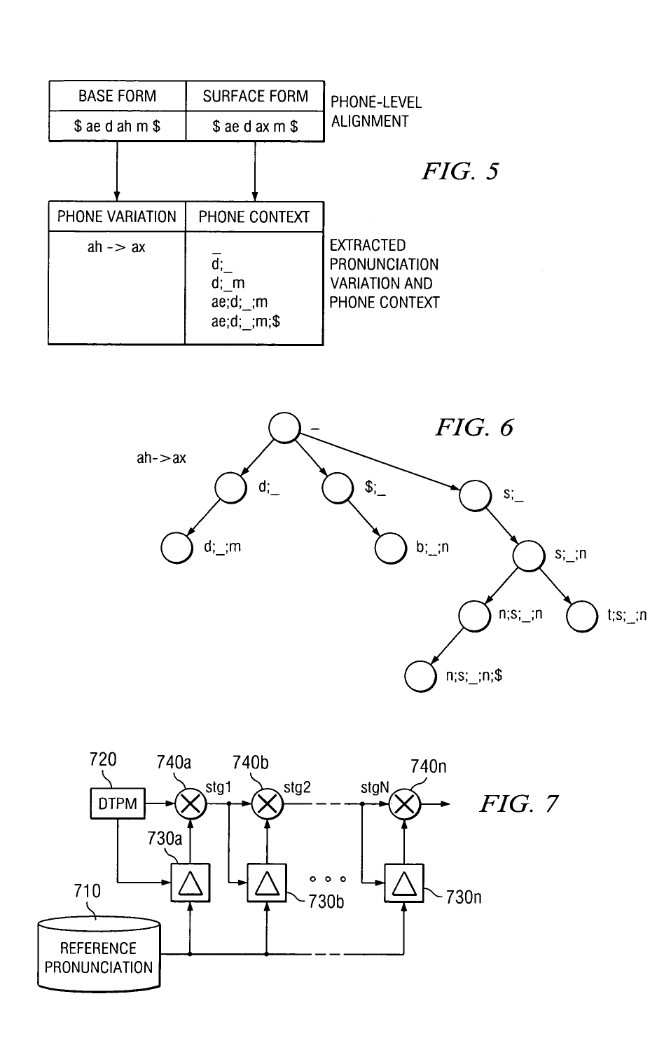

The first step is to align the base forms and the surface forms. Turning now to FIG. 5, if a mismatched pair of base forms and surface forms are found, their phone sequences are identified. A pattern of pronunciation variation is extracted, together with its preceding and succeeding phone context, and the number of its occurrence is counted. In this embodiment, up to two phones in both directions are considered as the phone context of the pattern. The word boundary is also considered as a context and is denoted as $.

Next, a tree-structured probabilistic rewrite rule set is generated for each variation pattern (the step 445 of FIG. 4). Let q denote a certain phone sequence with context c, and let q′ be the surface form variant of q. Let C(q|c) and C(q→q′|c) denote occurrence counts of base form q and surface form q′ with context c, respectively. A threshold θ_{c} is introduced for C(q|c) to select those contexts c and phones q with reliable statistics. That is, patterns that are more frequent than θ_{c} are adopted as rule candidates. The context-dependent phone transition probability is calculated as:

$$p ( q \to {q}^{′} \text{\vert} c ) = \frac{C ( q \to {q}^{′} \text{\vert} c )}{C ( q \text{\vert} c )} . \qquad ( 5 )$$

In this embodiment, at most the two preceding and the two succeeding phones are used as the context of the current phone. Let i and j be the length of the preceding and succeeding contexts, respectively. Let Rᵢⱼ denote a set of rules having a context lengths of i and j. Rules are defined in descending order, from the longest context set R₂₂ to a context-independent rule R.

For each pattern q→q′, the rule set is organized in a tree structure. Due to the tree-structured representation of context-dependent rewrite rules, some contexts are not allowed. More formally, given any context cεRᵢⱼ, other contexts in Rᵢⱼ do not overlap c. The rule sets described herein are therefore {R₂₂,R₂₁,R₁₁,R₁₀,R₀₀)}. FIG. 6 illustrates an example of such a tree structure. Each node denotes a certain context. A pattern probability, given by Equation (5), is associated with each node.

The rule set is then pruned (the step 450 of FIG. 4). The objective is to have reliable representation of context-dependent phone variation. A technique based on entropy may be advantageously applied. One embodiment of this technique will now be described.

Let a node n be denoted as a child of a node m if the context in node n is a subset of the context in node m and the difference of lengths of their contexts is one. Let Uₘ denote the set containing a child of node m. Let the phone transition probability p(q→q′|c) for context c at node m be denoted as pₘ. Given the probability, the entropy at node m is defined as:
Hₘ=−pₘ log₂ pₘ−(1−pₘ)log₂(1−pₘ). (6)
By further refining context of m to its children in Uₘ, the entropy of Uₘ is:

$${\hat{H}}_{m} = {\sum }_{n ∈ {U}_{m}} p ( n \text{\vert} m ) {H}_{n} , \qquad ( 7 )$$

where p(n|m) is the probability of occurrence a subset context represented at node n given its parent node of m, i.e.:

$$p ( n \text{\vert} m ) = \frac{C ( q \to {q}^{′} \text{\vert} c = n )}{C ( q \to {q}^{′} \text{\vert} c = m )} \qquad ( 8 )$$

Ĥₘ is then compared with Hₘ. Starting from the deepest context R₂₂, the pruning process is stopped when Ĥₘ>Hₘ. By the above process, the tree-structured rule set with all those nodes that have undergone the above process is pruned. After pruning, the context selected to transit phone q to q′ may not be as detailed as the rule set R₂₂ nor as general as the rule set R₀₀. For example, the context selected for the transition “ah” to “ax” is in rule set R₁₀. The above pruning process is then used for other nodes.

New surface forms are then generated by applying the pruned rule set (the step 455 of FIG. 4). In a lexicon, the rules having a longer context are first applied. The rules having a shorter context are then applied. When a context is located in a lexicon q, a new pronunciation q′ is generated with probability:
p(q′|W)←p(q|W)p(q→q′|c). (9)

Three alternative techniques of generating multiple pronunciations will now be described. A threshold of probability θₚ is assigned to prune those variations without sufficient probabilities.
1. The first alternative technique is single alternate pronunciation. The process of generating pronunciation variation is stopped until p(q′|W)<θₚ. The last pronunciation variation is adopted as the alternate pronunciation. This alternative will hereinafter be denoted as “A1.”
2. The second alternative technique is multiple alternate pronunciations. The process keeps all those generated pronunciation variations which have probabilities larger than θₚ. This alternative will hereinafter be denoted as “A2.”
3. The third alternative technique is probability re-write rules (see, e.g., Yang, et al., supra). The following Equation (10) is applied in addition to Equation (9) to generate pronunciation variations:
   p(q|W)←p(q|W)(1−p(q→q′|c)) (10)
   The objective is to allow possible pruning of the original pronunciation q. This alternative will hereinafter be denoted as “A3.”

Note that A3 differs from A1 and A2. Both A1 and A2 retain all base forms; A3 may discard base forms.

The pronunciations generated by these three alternatives are usually different. For example, Table 1, below, shows pronunciations generated for the name “Adam” by alternatives A1, A2 and A3.

TABLE 1
Pronunciations Generated by Alternatives A1, A2 and A3

| A1 | A2 | A3 |
|---|---|---|
| ae d ah m | ae d ah m | ae d ah m |
| | ae d ax m | ae d ax m |
| aa d ax m | aa d ax m | |

From Table 1, it may be observed that:
A1 is the most aggressive multiple pronunciation generation alternative. A1 generates alternate pronunciations using all possible contexts and phone variations.
A3 is less aggressive than A1, in that A3 generates pronunciation variations that may not use all possible contexts and phone variations.
A2 is conservative. A3 may discard base forms via Equation (10), whereas A2 always keeps the base forms. In contrast to A1, A2 has pronunciation variations that do not use all contexts and phone variations. A2 usually produces more pronunciation variations than other alternatives.

The speech-recognition performance of these three alternatives will be set forth below.

Having described certain embodiments of the combined technique, certain embodiments of a multi-stage phone-level pronunciation adaptation technique carried out in accordance with the principles of the present invention (hereinafter “multi-stage technique”) will now be described. As previously described, the multi-stage technique may be used for phone-level pronunciation adaptation in the combined technique. Recall that a word sequence is decoded via the MAP principle set forth in Equation (4) above. The objective therefore is to generate multiple pronunciations P that may improve recognition performance.

The multi-stage technique achieves this objective by minimizing a distance of multiple pronunciations to reference pronunciations. The similarity between two pronunciations, one being a reference pronunciation r and the other being a surface pronunciation s that is a variant of the reference pronunciation, is measured in terms of the edit, or Levenshtein, distance between the pronunciations (see, e.g., Levenshtein, “Binary Codes Capable of Correcting Deletions, Insertions, and Reversals,” Doklady Akademii Nauk SSSR, vol. 163, no. 4, pp. 845-848, 1965). The Levenshtein distance, denoted as D(s,r), is the minimum number of deletions, insertions or substitutions required to transform r into S. Here, the Levenshtein distance is extended to measure the distance of multiple pronunciations S with K-entries {sᵢ,iε{1, . . . ,K}} to the reference pronunciation r as:

$$Q ( S , r ) = {min}_{i ∈ \{ 1 , … , K \}} D ( {s}_{i} , r ) . \qquad ( 11 )$$

In other words, the shortest distance of these surface forms or the surface pronunciations {Sᵢ} to the reference pronunciation r is selected as the distance of S to r. The problem may be defined thus:
Find an operation f(•) that decreases the distance Q(f(S),r) relative to Q(S,r), i.e.,
   Q(f(S),r)≦Q(S,r), (12)
   where the operation f(•) on pronunciation entries {sᵢ,iε{1, . . . ,K}} is
   f(S)={f(sᵢ),iε{1, . . . ,K}}. (13)

The general idea of the multi-stage technique is to generate multiple pronunciations through a sequence of transformations f(•), where each of the transformations f(•) may include several steps. As stated in the objective above, each operation decreases the distance of the transformed pronunciations f(S) to the reference pronunciation r relative to that of the original pronunciations S.

It is therefore important to design f(•) to meet the goal. This may be achieved by the following probabilistic re-write rule technique for the operation f(•) (see, e.g., Akita, et al., supra, and Yang, et al., supra, for a general discussion of probabilistic re-write rule techniques).

At each stage, patterns of phone-level variations of an input pronunciation and a reference pronunciation are extracted. Based on the extracted patterns, a set of phone-level re-write rules is derived and pruned. Then, the rules are applied to the input pronunciations of the current stage. The output is used as input for the next stage, and the process repeats. FIG. 7 illustrates a block diagram of this technique. The technique employs a reference pronunciation dictionary 710. A baseline pronunciation model, e.g., a decision-tree-based pronunciation model, or DTPM 720, provides initial input pronunciations.

A plurality of stages cooperate to perform pronunciation adaptation. These stages, denoted stg1, stg2 . . . stgN include Δ logic blocks 730a, 730b, 730n and \textcircled{×} logic blocks 740a, 740b, 740n.

The A logic blocks 730a, 730b, 730n are employed to perform a delta analysis of the input pronunciation and the pronunciation from the reference pronunciation dictionary 810. The delta analysis includes extracting patterns of pronunciation variation, deriving phone-level re-write rules and pruning the re-write rules as described above.

The \textcircled{×} logic blocks 740a, 740b, 740n are employed to generate multiple pronunciations with the extracted rule set of this stage as described above. The output of each stage, e.g., stg1, stg2, is used as the input for the succeeding stage, e.g., stg2 . . . stgN.

As with the combined technique, two sets of pronunciations are used to extract phone-level pronunciation variation. The first set is taken from a reference dictionary containing true pronunciations. The second set is surface forms generated from the previous stage. A Viterbi alignment process then locates mismatched pairs of reference pronunciations and surface forms.

According to Equation (11), the surface pronunciation with the smallest Levenshtein distance to the reference pronunciation is selected. With the selected surface pronunciation, a pattern of pronunciation variation is extracted from the reference pronunciation as described above for the combined technique.

Next, as with the combined technique, a tree-structured probabilistic rewrite rule set is generated for each variation pattern. Let s denote a certain phone sequence with context c, and s′ be a variant of s. Let C(s|c) and C(s→s′|c) denote occurrence counts of base form s and surface form s′ with context c, respectively. A threshold θ_{c} is introduced for C(s|c) to select those contexts c and phones s with reliable statistics. That is, for those patterns that are more frequent than θ_{c} are adopted as rule candidates. The context-dependent phone transition probability is calculated as:

$$p ( s \to {s}^{′} \text{\vert} c ) = \frac{C ( s \to {s}^{′} \text{\vert} c )}{C ( s \text{\vert} c )} \qquad ( 14 )$$

Equation (14) is analogous to Equation (5) for base and surface forms. Again, at most the two preceding phones and the two succeeding phones are used as the context of the current phone. Let i and j be the length of the preceding and succeeding contexts, respectively. Let Rᵢⱼ denote a set of rules whose context length is i and j. Rules are defined in descending order, from the longest context set R₂₂ to a context-independent rule R₀₀.

For each pattern s→s′, the rule set is organized in a tree-structure. Due to the tree-structured representation of context-dependent rewrite rules, some contexts are not allowed. More formally, given any context cεR_{i,j}, other contexts in Rᵢⱼ do not overlap c. Referring back to FIG. 6, illustrated is an example of such a tree that, for this reason, has rule sets {R₂₂,R₂₁,R₁₁,R₁₀,R₀₀}. Each node denotes a certain context. A probability of pattern, given by Equation (14), is associated with each node.

The rule sets are pruned as described in conjunction with the combined technique. Again, the objective is to have reliable representation of context-dependent phone variation. Equations (6) and (7) and their accompanying definitions and descriptions, above, describe an exemplary pruning process. In the present discussion, p(n|m) is the probability of occurrence a subset context represented at node n given its parent node of m, i.e.:

$$p ( n \text{\vert} m ) = \frac{C ( s \to {s}^{′} \text{\vert} c = n )}{C ( s \to {s}^{′} \text{\vert} c = m )} \qquad ( 16 )$$

New surface forms are generated by applying the pruned rule set as described above. When a context is located in a lexicon s, a new pronunciation s′ is generated with probability:
p(s′|W)←p(s|W)p(s→s′|c). (16)
Note that Equation (16) is analogous to Equation (9), above.

A threshold of probability θₚ is assigned to prune those variations without sufficient probabilities. The process keeps all those generated pronunciation variation having probabilities larger than θₚ.

Notice that the original pronunciations S are retained. Adding new surface forms through Equation (16) does not increase the distance defined in Equation (11) of the transformed pronunciations relative to the reference pronunciation r, and therefore satisfies Equation (12).

Having described exemplary embodiments of the combined and multi-stage techniques, experimental results pertaining to one embodiment of the combined technique will now be described.

A name database, called WAVES, was used to provide the names for SIND. The WAVES database was collected in a vehicle using an AKG M2 hands-free distant talking microphone in three recording conditions: parked (car parked, engine off), city driving (car driven on a stop-and-go basis) and highway driving (car driven at a relatively constant speed on a highway). In each condition, 20 speakers (ten male, ten female) uttered English names. The WAVES database contained 1325 English name utterances. Because they were collected in cars, the utterances in the database were noisy. Multiple pronunciations of names also existed.

The WAVES database was sampled at 8 kHz, with frame rate of 20 ms. From the speech, 10-dimensional MFCC features and their delta coefficients were extracted. Baseline acoustic models were intra-word, context-dependent, triphone models. The acoustic models were trained from the well-known Wall Street Journal (WSJ) database with a manual dictionary. The models were gender-dependent and had 9573 mean vectors. To improve performance, these mean vectors were tied by a generalized tied-mixture (GTM) process (see, e.g., U.S. patent application Ser. No. 11/196,601), in which, in addition to the usual decision-tree-based state tying, a second stage of mixture-tying mechanism was applied to tie mixture components with these mean vectors. The baseline also used a pronunciation model trained from the well-known Carnegie Mellon University (CMU) dictionary (see, CMU, “The CMU pronunciation dictionary,” http://www.speech.cs.cmu.edu/cgi-bin/cmudict), which has 126,996 entries. Since the CMU dictionary has more proper names than the WSJ dictionary, pronunciation models trained from the CMU dictionary usually outperforms pronunciation models trained from the WSJ dictionary for SIND.

Because it was recorded using a hands-free microphone, the WAVES database presented several severe mismatches.
The microphone is distant-talking band-limited, as compared to a high-quality microphone used to collect the WSJ database.
A substantial amount of background noise is present due to the car environment, with SNR decreasing to 0 dB in highway driving.
Pronunciation variations of names exist, not only because different people often pronounce the same name in different ways, but also as a result of the data-driven pronunciation model.

Although not necessary to an understanding of the performance of the combined technique, the experiment also involved a novel technique introduced in application Ser. No. [Attorney Docket No. TI-39862AA], supra) and called “IJAC” to compensate for environmental effects on acoustic models.

Phone-level pronunciation adaptation required two dictionaries. A dictionary with base forms was generated from the decision-tree-based pronunciation model. Surface forms were from a manual dictionary containing names for recognition. θ_{c} was set to 1 for all following experiments.

First, the three alternative techniques of generating multiple pronunciations described above (A1, A2 and A3) were analyzed. The probability threshold θₚ was set to 0.05. Results of these alternatives are shown in Table 2, below.

TABLE 2
WER (in %) of WAVES Name Recognition Achieved
by Alternatives A1, A2 and A3

| WER (in %) | Parked | City Driving | Highway Driving |
|---|---|---|---|
| Baseline | 0.61 | 1.77 | 5.93 |
| A1 | 0.61 | 1.86 | 5.47 |
| A2 | 0.20 | 1.27 | 4.16 |
| A3 | 0.61 | 1.77 | 5.93 |

From Table 2, it may be observed that:
Alternatives A1 and A2 were effective in decreasing WERs, relative to the baseline, although their improvements were different. Alternative A3 did not improve performance relative to the baseline.
In terms of relative WER reduction, alternatives A2 and A1 each attained 32.4% and 0.9%.

The results show that lexicon modeling at the phone level using re-write rules (see, e.g., Yang, et al., supra) may not be desirable for SIND with data-driven pronunciation models. Based on the above observations, alternative A2 was selected for further experiments.

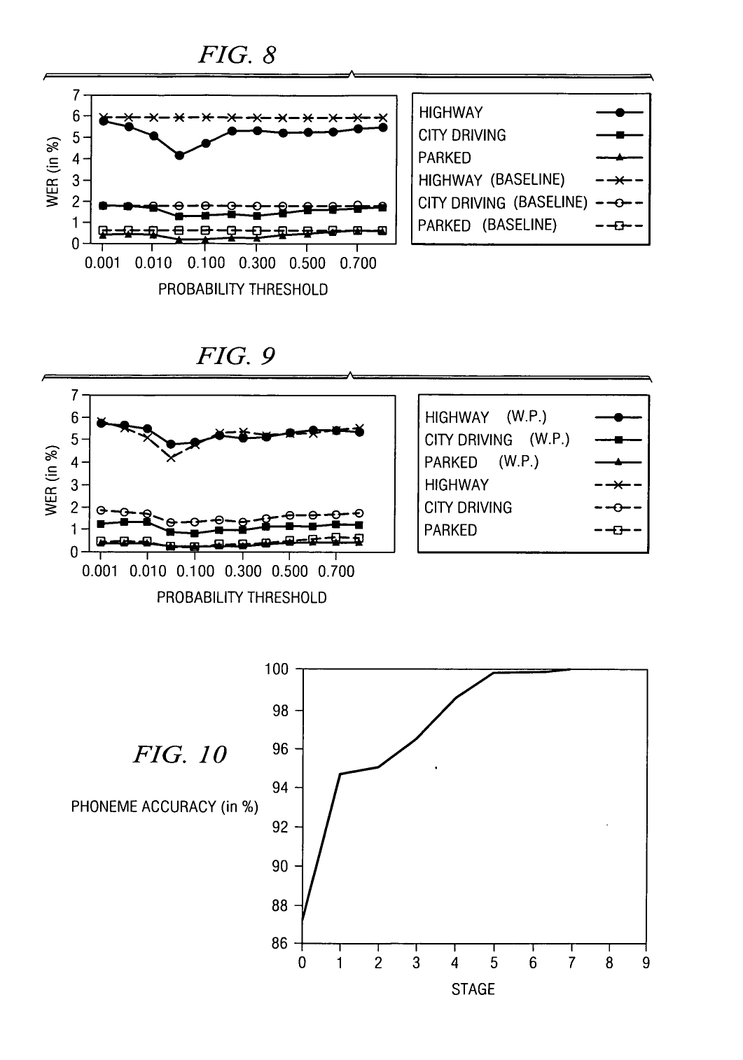

A probability threshold θₚ, is used for pruning rules with low probabilities. The larger the threshold, the fewer the number of pronunciation variations are explored. Experimental results with a set of θₚ are shown in Table 3, below, together with a plot of the results of phone-level-only pronunciation adaptation and the baseline performance in FIG. 8.

TABLE 3
WER of WAVES Name Recognition Achieved by
Phone-Level-Only Pronunciation Adaptation with Different
Probability Threshold θₚ

θₚ

| | 0.001 | 0.005 | 0.01 | 0.05 |
|---|---|---|---|---|
| Highway Driving | 5.78 | 5.51 | 5.08 | 4.16 |
| City Driving | 1.81 | 1.75 | 1.69 | 1.27 |
| Parked | 0.41 | 0.45 | 0.41 | 0.20 |

θₚ

| | 0.1 | 0.2 | 0.3 | 0.4 |
|---|---|---|---|---|
| Highway Driving | 4.71 | 5.27 | 5.31 | 5.19 |
| City Driving | 1.29 | 1.36 | 1.29 | 1.42 |
| Parked | 0.20 | 0.28 | 0.28 | 0.37 |

θₚ

| | 0.5 | 0.6 | 0.7 | 0.8 |
|---|---|---|---|---|
| Highway Driving | 5.23 | 5.25 | 5.41 | 5.47 |
| City Driving | 1.58 | 1.61 | 1.63 | 1.69 |
| Parked | 0.45 | 0.53 | 0.61 | 0.57 |

From Table 3, it may be observed that:
Phone-level-only pronunciation adaptation with a wide range of θₚ was able to decrease WER compared to the baseline.
A certain range of θₚ allows phone-level-only pronunciation adaptation to attain a relatively lower WER. For example, setting θₚ=0.05 results in the lowest WER in the highway driving condition. In comparison to the baseline, phone-level-only pronunciation variation with θₚ=0.05 decreased WER by 29.8%, 28.2% and 67.2% in highway driving, city driving and parked conditions, respectively. In view of the results shown in FIG. 8, θₚε(0.001,0.5) appears to yield the best performance for phone-level-only pronunciation adaptation.

Recognition results for the combination technique are shown in Table 4, below. FIG. 9 plots the performances, together with the performances of phone-level-only pronunciation adaptation given in Table 3, above.

TABLE 4
WER of WAVES Name Recognition Achieved by Combined
State- and Phone-Level Pronunciation Adaptation with Different
Probability Threshold θₚ

θₚ

| | 0.001 | 0.005 | 0.01 | 0.05 |
|---|---|---|---|---|
| Highway Driving | 5.72 | 5.62 | 5.46 | 4.78 |
| City Driving | 1.25 | 1.35 | 0.88 | 0.83 |
| Parked | 0.35 | 0.35 | 0.31 | 0.22 |

θₚ

| | 0.1 | 0.2 | 0.3 | 0.4 |
|---|---|---|---|---|
| Highway Driving | 4.86 | 5.13 | 5.05 | 5.11 |
| City Driving | 0.83 | 0.96 | 0.94 | 1.10 |
| Parked | 0.22 | 0.22 | 0.22 | 0.31 |

θₚ

| | 0.5 | 0.6 | 0.7 | 0.8 |
|---|---|---|---|---|
| Highway Driving | 5.27 | 5.40 | 5.42 | 5.31 |
| City Driving | 1.15 | 1.10 | 1.21 | 1.17 |
| Parked | 0.39 | 0.39 | 0.39 | 0.39 |

From Table 4, it may be observed that:
In city driving and parked conditions, the combined technique was able to outperform phone-level-only pronunciation adaptation.
Performances were comparable in highway driving conditions for phone-level-only pronunciation adaptation and the combination technique. However, the combination technique outperformed phone-level-only pronunciation adaptation in the range of θₚε(0.1,0.4).
A certain range of θₚ exists in which the combined technique attained a lower WER. For example, setting θₚ=0.05 results in lowest the WER in the highway driving condition. Together with the results shown in FIG. 8, θₚε(0.01,0.4) appears to yield maximum performance.
Averaging over three driving conditions and θₚ, the combined technique reduced WER by 0.01% compared to phone-level-only pronunciation adaptation. In particular, WER reduction was 27.9% and 17.3% in city driving and parked conditions, respectively.

Since the HMMs used for phone-level-only pronunciation adaptation also employed a data-driven mixture-tying technique found in U.S. patent application Ser. No. [Attorney Docket No. TI-39685], supra), pronunciation variation was implicitly used when the states to be tied happened to be located in the set of pronunciation variants. This may explain some of the performance results. However, the combined technique consistently and significantly outperformed phone-level-only pronunciation adaptation in the city driving condition.

Table 5 summarizes the performance of the combined technique compared to other techniques in dealing with pronunciation variations. The probability threshold θₚ for the combined technique was set to 0.05.

TABLE 5
WER of WAVES Name Recognition

| | | City | Highway | WER Reduction |
|---|---|---|---|---|
| Methods | Parked | Driving | Driving | Relative to Baseline |
| Baseline | 0.61 | 1.77 | 5.93 | — |
| Phone- | 0.20 | 1.27 | 4.16 | 41.8% |
| level-only | | | | |
| State- | 0.47 | 1.08 | 5.84 | 21.2% |
| level-only | | | | |
| Combined | 0.22 | 0.88 | 4.78 | 44.5% |

From Table 5, it may be observed that:
Compared to the baseline, both phone-level-only and state-level-only pronunciation adaptation are effective. In particular, phone-level-only pronunciation adaptation decreased WER by 42%, and state-level-only pronunciation adaptation decreased WER by 21%.
However, the combined technique effectively improved system performance dramatically over phone-level-only and state-level-only pronunciation adaptation. The combined technique attained 45% WER reduction as compared to the baseline.

Having set forth experimental results pertaining to one embodiment of the combined technique, experimental results pertaining to one embodiment of the multi-stage technique will now be set forth pertaining to one embodiment of the multi-stage technique.

Experiments were conducted to verify the efficacy of the multi-stage technique in adapting a baseline pronunciation to multiple pronunciations that may also improve recognition performance. A small dictionary of 665 entries of name pronunciations was used in the experiments. The pruning threshold θₚ was empirically set to 0.05, and θ_{c} was set to 1 according to recognition performances.

The baseline pronunciation models were trained from CALLHOME American English Lexicon (PRONLEX) (see, e.g., LDC, “CALLHOME American English Lexicon,” http://www.ldc.upenn.edu/). Since the task at hand is SIND, entries for letters such as “.” and “'” were removed from the dictionary. Pronunciation of some English names was added into the dictionary. The final dictionary had 96,500 entries with multiple pronunciations. A decision tree of each letter was trained after a text-to-phoneme alignment (see, e.g., U.S. patent application Ser. No. [Attorney Docket No. TI-60422], supra). Because of the decision-tree-based approach, the baseline pronunciation models generated a single pronunciation for each word.

The WAVES database described above, this time containing 1325 English name utterances, was used. Baseline acoustic models were intra-word, context-dependent, triphone models. The acoustic models were trained from the well-known Wall Street Journal (WSJ) database with manual dictionary. The models were gender-dependent and had 9573 mean vectors. Although not necessary to the present invention but to improve performance, these mean vectors were tied by a generalized tied-mixture (GTM) process (see, e.g., U.S. patent application Ser. No. 11/196,601, supra), in which, in addition to usual decision-tree-based state tying, a second stage of mixture-tying mechanism was applied to tie mixture components with these mean vectors. Like the experiments above, IJAC was used to compensate environmental effects on acoustic models. However, the pronunciation model was not trained using the CMU dictionary.

The Levenshtein distance is related to the phoneme accuracy. The phoneme accuracy is defined as:

$$Phoneme accuracy = \frac{N - D - S - I}{N} , \qquad ( 18 )$$

where N is the total number of phonemes in the reference pronunciations. D, S and I respectively denote the number of deletion errors, substitution errors and insertion errors, which are obtained by alignment of the surface pronunciations with the reference pronunciations. The higher the accuracy, the smaller number of errors and therefore the smaller Levenshtein distances from surface pronunciations to the reference pronunciations.

FIG. 10 shows phoneme accuracy as a function of stage number and demonstrates that phoneme accuracy increased after each processing stage. This confirms that the multi-stage technique is able to decrease the Levenshtein distance between two sets of pronunciations. From FIG. 10, the first stage of the multi-stage technique was able to increase phoneme accuracy by 8%. Improvements of phoneme accuracies ranged from 0% to 2% in succeeding stages. After the 6^{th} stage, phoneme accuracy attained 100%.

Table 6, below, shows the number of data-driven probablilistic re-write rules at each stage.

TABLE 6
Number of Data-Driven Rules at Each Stage

| | Stage n | | | | | | | | | |
|---|---|---|---|---|---|---|---|---|---|---|
| | 1 | 2 | 3 | 4 | 5 | 6 | 7 | 8 | 9 | 10 |
| Number | 183 | 135 | 107 | 97 | 92 | 87 | 86 | 85 | 83 | 83 |
| of rules | | | | | | | | | | |

From Table 6, it may be observed that the number of rules decreased from 183 at the 1^{st} stage to 83 at the 4^{th} stage. The experiments, taken together, confirm that the multi-stage technique is both effective and efficient.

Name recognition experiments were then conducted to verify if the multi-stage technique can improve recognition performance. Results are shown in Table 7, below.

TABLE 7
WER of WAVES Name Recognition Achieved
by the Multi-Stage Method

| | Stage | | | | |
|---|---|---|---|---|---|
| | 0 | 1 | 2 | 3 | 4 |
| Highway | 9.51 | 7.49 | 7.08 | 7.02 | 6.75 |
| Driving | | | | | |
| City | 3.71 | 2.40 | 2.06 | 2.11 | 2.06 |
| Driving | | | | | |
| Parked | 1.67 | 0.83 | 0.73 | 0.65 | 0.65 |

From Table 7, it may be observed that:
In three driving conditions, the multi-stage technique decreased WERs significantly. For instance, the WER in the highway driving condition was decreased from 9.51% with single pronunciation by the baseline DTPM, to below 7% after the 4^{th} stage. Such improvement represents a 29% WER reduction. The technique decreased WER by 44% and 61% in city driving and parked conditions, respectively. In average of the three driving conditions, WER was reduced 45%.
WERs were not decreased monotonically. This observation suggests that the multi-stage technique may not always improve recognition performance, although it always attains phoneme accuracy improvement at each stage.

To achieve a good compromise between performance and complexity, it may be desirable to use a look-up table containing phonetic transcriptions of those names that the multi-stage technique does not correctly generate. While the look-up table may require a modest amount of additional storage space, performance may be significantly increased as a result.

Although the present invention has been described in detail, those skilled in the pertinent art should understand that they can make various changes, substitutions and alterations herein without departing from the spirit and scope of the invention in its broadest form.

What is claimed is:

1. A system for combined state- and phone-level pronunciation adaptation, comprising:
a pronunciation variation analyzer configured to use an alignment process to compare base forms of words with alternate pronunciations and generate a confusion matrix;
a state-level pronunciation adapter associated with said state-level pronunciation variation analyzer and configured to employ said confusion matrix to generate, in plural states, sets of Gaussian mixture components corresponding to alternative pronunciation realizations and enlarge said sets by tying said Gaussian mixture components across said states based on distances among said Gaussian mixture components; and
a phone-level pronunciation adapter associated with said state-level pronunciation adapter and configured to employ phone-level re-write rules to generate multiple pronunciation entries.

2. The system as recited in claim 1 wherein said distances are Bhattacharyya distances.

3. The system as recited in claim 1 wherein said state-level pronunciation adapter is further configured to re-initialize and re-train mixture weights associated with said Gaussian mixture components using an E-M-type algorithm.

4. The system as recited in claim 1 wherein said phone-level pronunciation adapter is further configured to generate said phone-level re-write rules by extracting patterns of phone-level pronunciation variations together with phone contexts and occurrence counts.

5. The system as recited in claim 4 wherein said phone-level re-write rules are probabilistic phone-level re-write rules and said phone-level pronunciation adapter is configured to employ an entropy-based technique to prune said phone-level re-write rules.

6. The system as recited in claim 1 wherein said phone-level pronunciation adapter is embodied in a plurality of stages.

7. The system as recited in claim 6 wherein, at each of said plurality of stages, said phone-level pronunciation adapter is configured to extract patterns of phone-level variations of input pronunciations and reference pronunciations, derive and prune said phone-level re-write rules and apply said phone-level re-write rules to said input pronunciations.

8. The system as recited in claim 6 wherein a number of said stages is predetermined based on recognition results.

9. The system as recited in claim 1 wherein said multiple pronunciation entries are used to train hidden Markov models over plural iterations.

10. The system as recited in claim 1 wherein said system is embodied in a digital signal processor.

11. A method of combined state- and phone-level pronunciation adaptation, comprising:
using an alignment process to compare base forms of words with alternate pronunciations and generate a confusion matrix;
employing said confusion matrix to generate, in plural states, sets of Gaussian mixture components corresponding to alternative pronunciation realizations and enlarge said sets by tying said Gaussian mixture components across said states based on distances among said Gaussian mixture components; and
employing phone-level re-write rules to generate multiple pronunciation entries.

12. The method as recited in claim 11 wherein said distances are Bhattacharyya distances.

13. The method as recited in claim 11 further comprising re-initializing and re-training mixture weights associated with said Gaussian mixture components using an E-M-type algorithm at a state level.

14. The method as recited in claim 11 further comprising generating said phone-level re-write rules by extracting patterns of phone-level pronunciation variations together with phone contexts and occurrence counts.

15. The method as recited in claim 14 wherein said phone-level re-write rules are probabilistic phone-level re-write rules and said method further comprises employing an entropy-based technique to prune said phone-level re-write rules.

16. The method as recited in claim 11 wherein said employing said phone-level re-write rules is carried out in a plurality of stages.

17. The method as recited in claim 16 wherein, at each of said plurality of stages, said employing said phone-level re-write rules comprises extracting patterns of phone-level variations of input pronunciations and reference pronunciations, deriving and pruning said phone-level re-write rules and applying said phone-level re-write rules to said input pronunciations.

18. The method as recited in claim 16 wherein a number of said stages is predetermined based on recognition results.

19. The method as recited in claim 11 further comprising using said multiple pronunciation entries to train hidden Markov models over plural iterations.

20. The method as recited in claim 11 wherein said method is carried out in a digital signal processor.
